(19) United States
(12) Patent Application Publication
(10) Pub. No.: US 2021/0214930 A1
(43) Pub. Date: Jul. 15, 2021

(54) DRAIN CONTROL INSECT ABATEMENT METHODS, DEVICES AND SYSTEMS

(71) Applicant: Elixpro Inc., Chicago, IL (US)

(72) Inventors: Patrick J. JOYCE, Chicago, IL (US); Paul D. CANAVAN, Chicago, IL (US)

(73) Assignee: Elixpro Inc., Chicago, IL (US)

(21) Appl. No.: 16/093,582

(22) PCT Filed: Apr. 12, 2017
(86) PCT No.: PCT/US2017/027259

§ 371 Date: Oct. 12, 2018

Related U.S. Application Data
(60) Provisional application No. 62/322,012, filed on Apr. 13, 2016.

(51) Int. Cl. E03F 7/06; E03F 5/06; F16K 15/03; F16K 15/04; E03C 1/28

(52) U.S. Cl. CPC E03F 7/06; E03F 5/06; E03C 1/281; F16K 15/04; F16K 15/03

(57) ABSTRACT

Insect blocking devices having floats and flappers to prevent insect access to standing water in traps. A device for insertion into a trap having a float that seals the trap from insects, when in-flow water is not present, and opens as a result of in-flow water, to permit in-flow water to pass and enter the trap.

This application claims the benefit of the filing date of U.S. provisional application Ser. No. 62/322,012, filing date of Apr. 13, 2016, the entire disclosure of which is incorporated herein by reference.

### BACKGROUND OF THE INVENTION

### Field of the Invention

The present inventions relate mechanical and fluid-mechanical devices for controlling insect access to standing water in drain pipes and other water collection, handling and management basins, tubulars and systems. In many of these types of systems, standing water is kept in a trap device that is part of the system. The water in the trap prevents gases from escaping from the open end of the drain or pipe into the atmosphere. These escaping gases can be unpleasant smelling, noxious, hazardous, and at times are commonly referred to as sewer gases.

As used herein, unless expressly provided otherwise, the term “trap” and similar such terms, should be given their broadest possible meaning, and would include any plumbing, piping assembly, or system having a configuration that holds water within a pipe, channel or tubular, in a manner that provides a seal to gases, the seal may be solely fluid based, or may be a combination of fluid and mechanical (e.g., a flapper door, diverter and pool) based, and would include P-traps, U-shaped traps, S-shaped traps, flapper doors, storm drains and catch basins. Traps would include pipes that are generally round, e.g., circular, that have internal diameters from about ¼ inch to about 60 inches, although larger and smaller sizes and other shapes, such as square, polygon, rectangular, and oval, to name a few, may be utilized.

As used herein, unless express provided otherwise, the term “pipe”, should be given its broadest possible meaning and would include any member having a length that is longer than its cross section and having a cavity or hollow internal passage, as well as, conduits, channels, tubulars, drains, drain pipes, and would also include members having an internal cavity having a circular shaped cross section, square shaped cross section, rectangular shaped cross section, oval shaped cross section, and other shaped cross sections. The exterior of the pipe may be the same or similar shape as the interior cavity or it may be different, e.g. interior cavity having an oval shape and exterior shape being rectangular. A pipe can be made from any material that meets its use requirements, including building codes, pressure ratings, environmental requirements, and would including metal, steel, iron, copper, lead, PVC, composite, plastic, concrete, terracotta, and ceramic.

Many kinds of insects, and particularly mosquitoes, bread in, lay eggs in, or otherwise need standing water for creating progeny. Thus, standing water in traps, drains, and other pipes, both indoors, and out doors, although out doors can generally be of greater concern, provide locations where mosquitoes and other insects can bread or otherwise increase their numbers. In additional to be generally annoying, mosquitoes can present signification health problems to humans, livestock and wildlife. Among the diseases that mosquitoes can spread, or are associated with, include Malaria, Zika, Encephalitis, West Nile, Yellow Fever, Rift Valley Fever, Dengue Fever, Filarasis, Pogosta disease, to name a few.

Generally, the term “about” as used herein unless specified otherwise is meant to encompass a variance or range of ±10%, the experimental or instrument error associated with obtaining the stated value, and preferably the larger of these.

This Background of the Invention section is intended to introduce various aspects of the art, which may be associated with embodiments of the present inventions. Thus the forgoing discussion in this section provides a framework for better understanding the present inventions, and is not to be viewed as an admission of prior art.

### SUMMARY

Accordingly, there has been a long-standing and increasing need for new ways to block insect access to standing water, and in particular, standing water in drains and traps, while at the same time permitting the drains and traps to properly function. The present inventions, among other things, solves these and other long standing needs, and provides significant public health benefits, by providing the devices, methods, and systems taught and disclosed in the specification, drawings and claims.

Thus, there is provided a device for retrofitting a pipe to block insect access to standing water in the pipe, the device having: a stopper capable of moving from a first position to a second position; a sealing member, wherein the stopper engages the sealing member in the first position and thereby forms an insect blocking seal; the stopper capable of moving to the second position by the action of in-flow water, wherein the movement of the stopper opens a channel for the flow of the in-flow water past the stopper and the sealing member; and wherein the stopper is capable of returning to the first position up the sensation of the in-flow water.

Further, there is provided these devices, systems and methods having one or more of the following features: wherein the stopper is a hinged flap; wherein the stopper is a float; wherein the stopper is spherical; wherein the device comprises a float guide; wherein the device comprises a plurality of float guides; wherein the float guide is a treaded rod; wherein the sealing member is a ring; wherein the device has a ring having an inner serrated edge positioned above the sealing member; and, wherein in the first position the stopper is engaged against both the inner serrated edge and the sealing member.

Moreover, there is provided the method of retrofitting a drain, having a trap capable of holding standing water, the method including installing the device of an embodiment of the present invention into a drain opening.

Still further there is provided a method of blocking insect access to standing water in a trap, the method including: providing a float device in engagement with a sealing member in a pipe above standing water in a trap in the pipe, and between the trap and an opening of a pipe in fluid communication with the trap, the float device engaging with the sealing member and thereby preventing insects from traveling past the sealing member, wherein the insects cannot reach standing water in the trap; upon the in-flow of water into the opening the float floats way from the sealing member, whereby a flow passage is opened; flowing the in-flow water through the pipe into the trap and out of the trap; wherein when the in-flow water subsides the trap remains filled with standing water, sealing the trap, and wherein the float re-engages with the sealing member, thereby blocking insect access to the standing water in the trap.

Additionally, there is provided a device for blocking insect access to standing water in a trap, the device having: a grating; a first annular member; a housing; the housing having an upper end and a lower end and comprising a first post, a second post, a first window, and a second window; the first annular member connecting the grating to the upper end of the housing, whereby the grating is in fluid communication with the housing; the housing having an upper and a lower external selling ring, the sealing rings positioned adjacent an outer surface of the housing, and capable of engaging the inner surface of a pipe; a stopper located in the housing, and movable from a first position within the housing to a second position within the housing; and, a sealing member located within the housing and positioned near the lower end of the housing, wherein the stopper engages the sealing member in the first position and thereby forms an insect blocking seal.

Yet additionally, there is provided these devices, systems and methods having one or more of the following features: a ring having an inner serrated edge positioned above the sealing member, wherein in the first position the stopper is engaged against both the inner serrated edge and the sealing member; wherein the first annular member is a split ring, and engages an inner surface of the housing; and wherein the lower end of the housing comprises a gap.

### BRIEF DESCRIPTION OF THE DRAWINGS

FIG. 1 is a cross sectional view of an embodiment of a drain covering device in accordance with the present inventions.

FIG. 2 is a perspective view of an embodiment of a drain covering device in accordance with the present inventions.

FIG. 2A is a perspective cutaway view of the embodiment of FIG. 2 in a drain in accordance with the present inventions.

FIGS. 3A to 3D are cross sectional schematic views of embodiments of drain closing devices in accordance with the present inventions.

FIGS. 4A to 4B are cross sectional schematic views of embodiments of drain closing floats in accordance with the present inventions.

FIG. 5 is a partial cutaway view of an embodiment of drain closing device in a trap in accordance with the present inventions.

FIG. 6 is a perspective view of an embodiment of a drain closing device in accordance with the present inventions.

FIG. 7A is a plan view of an embodiment of a drain cover, covering the drain closing device of FIG. 7B in accordance with the present inventions.

FIG. 7B is a cross sectional view of an embodiment of a drain closing device in accordance with the present inventions.

FIG. 8 is a perspective view of an embodiment of a drain closing device in accordance with the present inventions.

FIG. 8A is a perspective view of the serrated sealing member used in the device of FIG. 8.

FIG. 8B is a perspective view of the upper sealing ring used in the device of FIG. 8.

### DESCRIPTION OF THE PREFERRED EMBODIMENTS

In general, the present inventions relate to unique devices to control insect access to standing water that is held in drains, pipes or water handling and collection systems.

In general, the present inventions relate to mechanical and fluid-mechanical devices for controlling insect access to standing water in drain pipes and other water collection, handling and management basins, tubulars and systems. The present devices in general have a moving member that engages a sealing member to block insect access to any water that may be held at or below the sealing member. When additional water enters the system, the additional water causes the moving member to disengage from the sealing member, creating a passage allowing the additional water to flow into system.

In general, in an embodiment the sealing device can be a float. The float can be any shape, and made from any material or combinations of materials that are light enough, (e.g., have a density that is about 1.5 g/cc, preferably 1.0 g/cc or lighter), so that they are buoyant, and can be lifted or moved by water pressure. The float is positioned in the system (e.g., a pipe) in, or above, the water in the system (e.g., standing water in a trap in the pipe). The float is engaged with a seating or sealing member in the system. The seating member can be a ring, lip, constriction in a system, and inner surface of a pipe, to name a few. In this manner the float engages the sealing member and blocks insect access to the water. When additional water flows into the system, from for example rain, run-off, used water from washing or cleaning, or waste water from an activity, the in-flowing additional water moves the float away from the seating member permitting the additional water to flow by the float and along the pipe. Typically, the float moving away from the seating member creates, opens, or provides access to, a passage, annulus, channel or other opening, through which the additional water can flow around the float and down, or long, the system.

Embodiments of the sealing devices can be retrofit devices. In this manner the retrofit device has an assembly that has a float and sealing member. Preferably, the retrofit device has an attachment member, or members, that connects the sealing member with a top, which can be a lip, grate, or perforated cover that sits atop a opening in a system (e.g., the opening of a pipe). Preferably, the attachment member creates a guide for the movement of the float, and thus the engagement and disengagement of the float with the sealing member, as well as the forming of a passage through which the additional water can flow. The outer diameter, or configuration of the retrofit device, is such that it can be inserted into an existing system, e.g., drain or pipe. The retrofit device can be an integral assembly, or can be made from several components that are affixed together, and combinations and variation of these. The retrofit assembly and the components can be assembled, or manufactured, by any manufacturing and fastening techniques, such as threaded members, bolts, press fits, tabs, welding, soldering, molding, gluing, machining, as well as other techniques and combinations and variations of these.

Embodiments of the sealing devices can be integral with the system. In this manner the seating member and the guide for the movement of the float can built into the system. Thus, in an embodiment, a trap can have built into it a float and sealing member, so that when the trap is installed into a water handling systems, such as a drain, the system will block insect access to standing water in the trap.

Embodiments of the sealing devices can be combinations and variations of retrofit and integral devices. Thus, for example, traps can have a sealing member so that after installation only the sealing float needs to be added. Other variations and combinations of retrofit and integral devices are contemplated by the present inventions.

The sealing devices, including the moving member, seating member, flaps, floats, attachment members, grates can be made from one or more of PVC, plastic, metal, composites, natural materials such as cork, materials that pipes and water handling systems are made from, and combinations and variations of these.

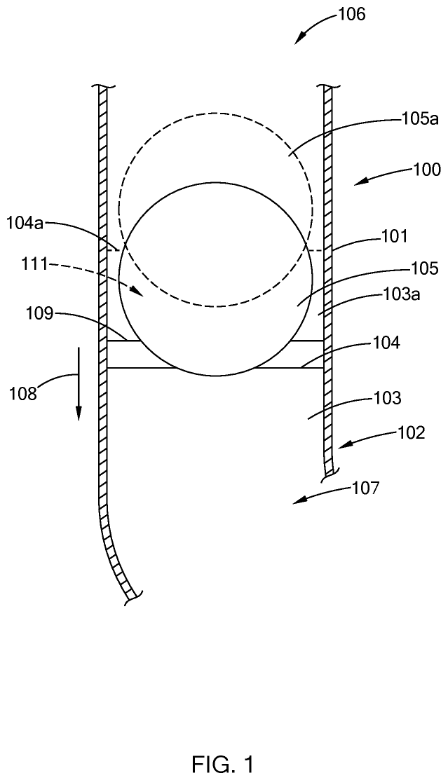

Turning to FIG. 1 there is shown a cross section of an embodiment of the present sealing devices. In this embodiment a pipe 100 has a pipe wall 101. The pipe 100 has a trap section 102 (only partially shown in the figure). The trap section 102 has standing water 103 having a surface 104. A float 105 is seated against a sealing member 109. In this embodiment the float 105 is in the standing water 103, while engaged against the sealing member 109. The float 105 engaging against the sealing member 109 blocks insect access to the standing water 103 in the trap section 102.

When in-flowing additional water enters the opening 106 of the pipe 100 the float is lifted by the raising level of the water 103a, which is raised to a level 104a, and has the float in a disengaged position 105a, where the disengaged float 105a is removed from and not engaged with the sealing member 109. The disengaged, or open, float 105a is raised by water 103a having surface 104a. In this manner a passage 111 is created between the outer surface of the float 105a and the inner surface of the pipe wall 101 and the sealing member 109. In this embodiment the sealing member 109 can be a ring having a central opening. The in-flowing water travels in the direction of arrow 108 around the float 105a through the passage 111 in the direction of arrow 108 and eventually into a water collection system 107, e.g., a sewer.

### EXAMPLES

The following examples are provided to illustrate various embodiments of operation and configurations of the insect blocking devices of the present inventions. These examples are for illustrative purposes, and should not be viewed as, and do not otherwise limit the scope of the present inventions.

### Example 1

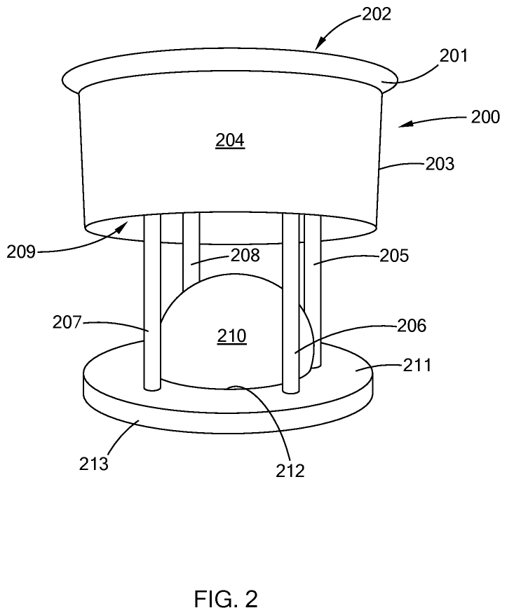

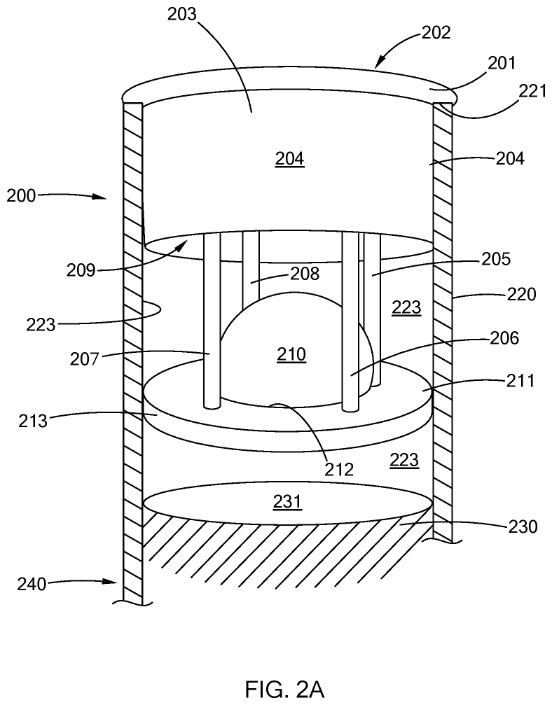

Turning to FIG. 2, there is shown a perspective view of an embodiment of a retrofit device 200. The retrofit device 200 is for insertion into a water handling system. The device 200 has a lip 201 that is formed from a drain plate 202, e.g., grate. A sleeve 203 has an outer surface 204. The sleeve 203 has a smaller outer diameter that the lip 201. The device 200 has four guide rods 205, 206, 207, 208. The guide rods 205, 206, 207, 208 connect the drain plate 202 with the sealing ring 211. The device 200 has an inner cavity 209 for the flow of in-flow added water. The plate 202 and sleeve 203 form an upper section of the device 200. The guide rods connect the upper section and the ring 211 which forms a lower section of the device 200. The guide rods from a channel that contains the float 210. The sealing ring 211 has an inner opening 212 and an outer surface 213. As shown in FIG. 2, the float 210 is seated against the ring 211, blocking the inner opening 212.

### Example 2

Turning to FIG. 2A, there is shown the retrofit device 200 of FIG. 2, positioned in a drain pipe 220. The drain pipe 220 has a top end 221 that engages the lip 201. In this manner the lip 201 holds the device 200 from falling into the drain pipe 220. As inserted in the pipe 220 the outer surface 204 of the sleeve 203 engages the inner surface 223 of pipe 220. The outer surface 213 of ring 211 engages the inner surface 223 of pipe 220. The pipe 220 has a trap 240 having standing water 230 having a surface 231. The surface 231 of the water 230 is below the ring 211, and the float is not in the water 230.

In operation as in-flowing water enters the pipe 220 through plate 202 it flows through cavity 209, willing the cavity 209 and floating float 201 lifting it and disengaging it from the ring 211. The disengaged float creates an opening between the float and the opening 212 in the ring 211. The guides control the movement of the float so that when the in-flowing water stops the float will settle back down and re-engage the ring 211, blocking the opening 212.

Thus, the float 210 will disengage and re-engage the ring 211 as in-flowing water is present and subsides in the pipe 220.

### Example 3

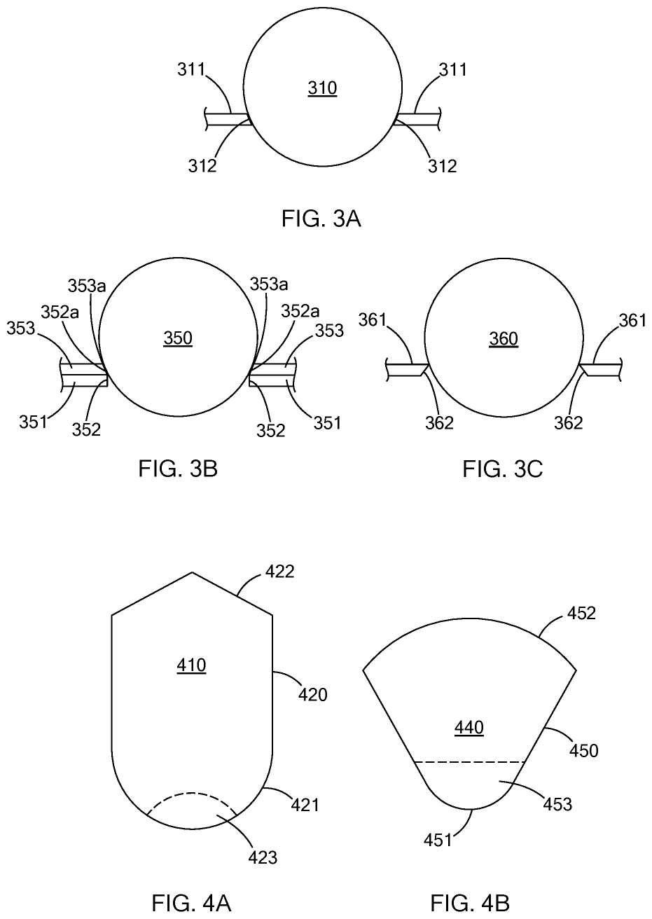

Turning to FIG. 3A, there shown a cross section of an embodiment of the inner face 312 of a sealing member 311. In this embodiment the float 310 is seated against the inner surface 312 of the ring. The inner surface 312 is shaped to follow the shape of the float. Thus the inner surface 312 has in inward taper. The inner surface 312 can be flat, or curved to more closely follow the shape of the float 310.

### Example 4

Turning to FIG. 3B, there shown a cross section of an embodiment of the inner face 352 of a sealing member 351. In this embodiment the float 350 is seated against the inner edge 352a of the inner surface 352 of the ring 351. The inner edge 352a is the top corner of a flat face of surface 352 of the ring 351. Thus the inner surface 352 of the ring 351 does not have any taper. Above and adjacent to the sealing member 351 is a ring 353 having an inner serrated surface 353a. The inner serrated (e.g., grooved, channels, small flow paths) surface contacts the float 350. The serrated ring 353 in conjunction with the sealing member help to guide and seat the float as the water drains away, and also provides for better, or more complete draining of water before the float 350 is seated against edge 352a. Thus, the float contacts both the inner serrated surface 353a and the sealing ring edge 352a when it is in the sealed or seated position.

In embodiments the inner serrated edge, if the serrations are of a sufficient shape, e.g., length, width or other profile, as to form an effective insect barrier, can also function as a sealing member.

### Example 5

Turning to FIG. 3C, there shown a cross section of an embodiment of the inner face 362 of a sealing member 361. In this embodiment the float 360 is seated against the edge of the inner surface 362 of the ring 361. The inner edge of surface 362 is shaped as an outward taper.

### Example 6

Turning to FIG. 4A, there is shown an embodiment of a float 410. The float has a pointed or conical upper end 422, which is designed to prevent water from collection on the top of the float. The float has essentially straight side walls 420 and has a curved (spherical) bottom section 412. The bottom section 421 is the engagement section for engaging against a seating member. In this embodiment the float 410 has a weighed section 423 at its bottom. The weighted section assists in the re-engagement of the float with the seating member after in-flowing water subsides.

### Example 7

Turning to FIG. 4B, there is shown an embodiment of a float 440. The float has a curved top end 452, which is designed to prevent water from collection on the top of the float. The float is essentially conical, having tapered straight side walls 450 and has a slightly curved, and essentially flat bottom section 451. The bottom section tapered side wall 450 is the engagement section for engaging against a seating member. In this embodiment the float 440 has a weighed section 453 at its bottom. The weighted section assists in the re-engagement of the float with the seating member after in-flowing water subsides.

### Example 8

The sealing and insect blocking device has cleaning members, such as ridges, fluted scrapers, and the like for cleaning the outer surface of the float as it moves in the device, i.e., as it disengages and re-engages the seating member.

### Example 9

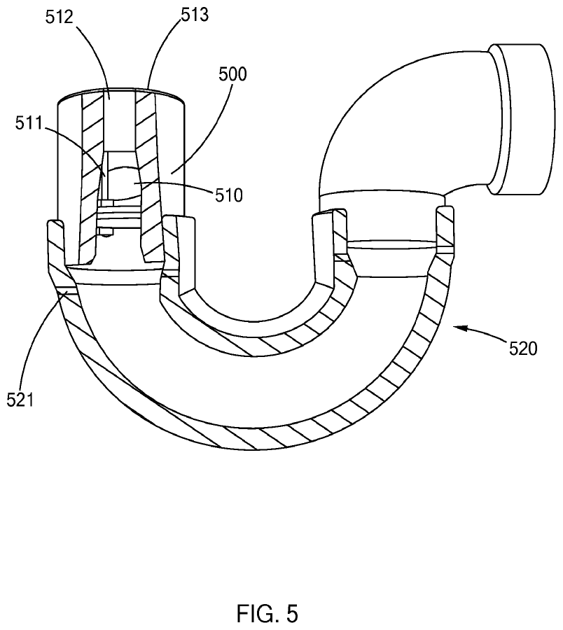

Turning to FIG. 5, there is shown a partial cutaway view of an embodiment of an integral trap sealing and insect blocking device 520. The device 520 has a trap section 521 that holds standing water (no shown in the figure). The device 520 has a sealing device 500 having a cover grate 513, an inner sleeve 512, four guide members (only one guide member 511, is seen in the cutaway view of the figure) and a float 510.

### Example 10

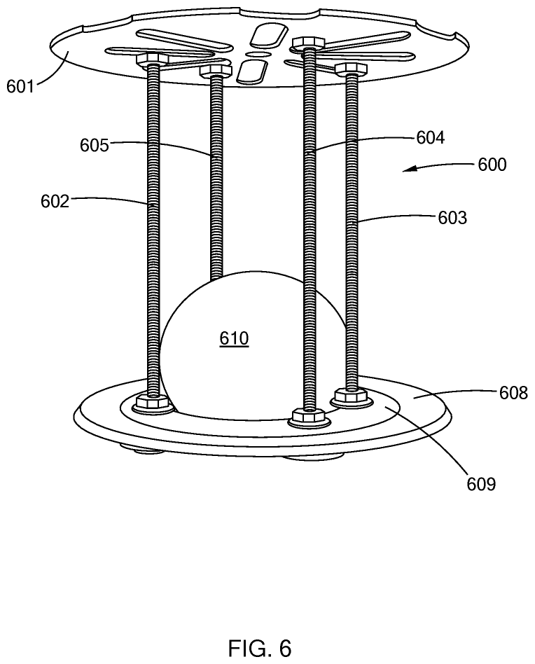

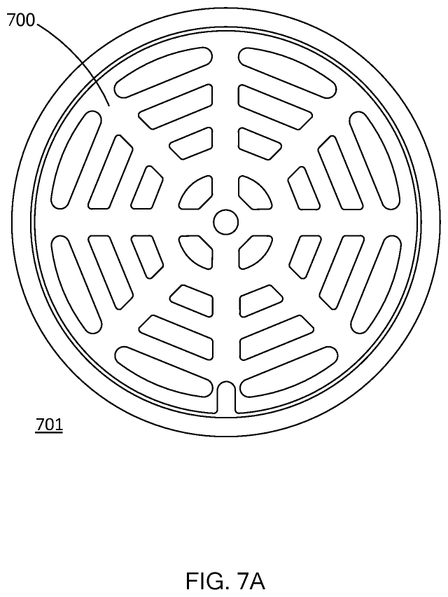

Turning to FIG. 6 there is shown a perspective view of an embodiment of a retrofit device 600. The device 600 has a top grate 601, four guide members 602, 603, 603, 605 and a float 610. The float 610 is shown engaged against the sealing member, e.g., ring, 608. In this embodiment the sealing member 608 is a flexible member, made from a rubber or plastic material. The flexible member 608 has a stiffening inner ring 609. The stiffening inner ring 609 engages the float 610. The flexible member 608 engages the inner wall of the pipe (not shown in the figure) that the retrofit device 600 is inserted into.

In another embodiment the flexible member 608 also engages the float 610.

The stiffening member 609 also provides an area or point of attachment for the guide members 602, 603, 604, 605.

### Example 11

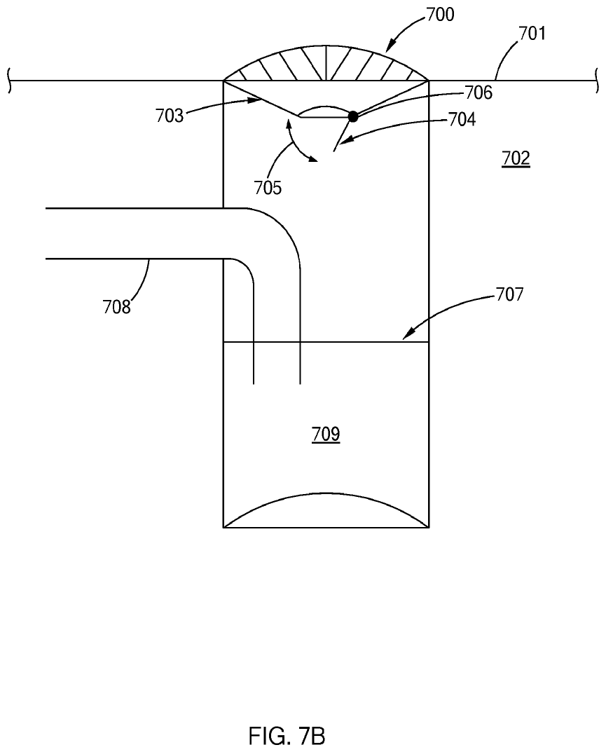

Turning to FIGS. 7A and 7B there is shown an embodiment of a storm drain catch basin 720. The catch basin 720 has a perforated lid 700, e.g., a heavy metal grate. A cone shaped collector 703 has an opening at its bottom that has a hinge member 706 attaching a trap door or flap 704 that moves as shown by arrow 705. As in-flow water fills the collector 703 its weight causes flap 704 to swing open (as shown in the FIG. 7B) and allow the water to flow into the basin. The basin 720 is located in the ground 702 at and below the surface 701. The basin has water 709 having a water level and water surface 707, which is below the flap 704. A pipe 708 connected to the main sewer is also in the basin and in fluid communication with the water 709. When the flap 704 is closed, insect access to the the water 709 and the surface of the water 707 is blocked. The hinge 706 member is biased, or otherwise has a spring, flexible joint, or other closing device, so that when in-flow water has subsided the flap will move to the closed position. The bottom edge of collector 703 is, or has, the seating member for the flap 704.

### Example 12

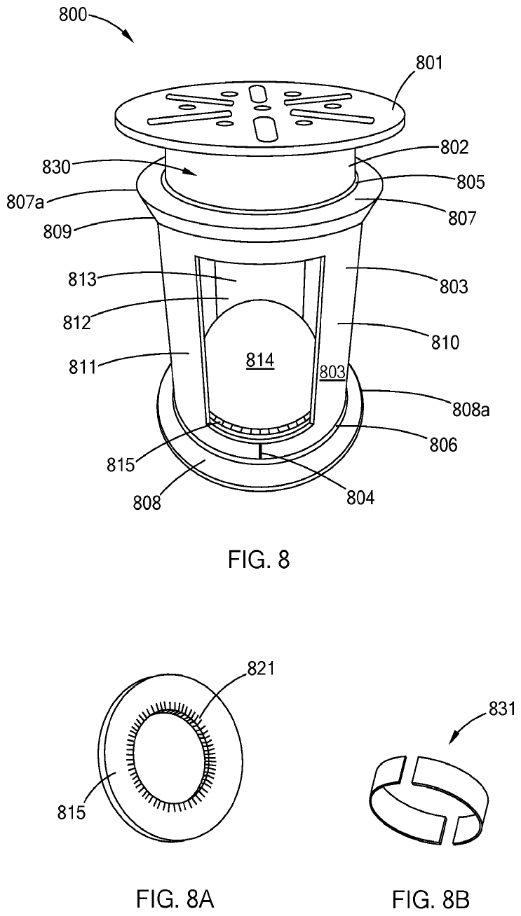

Turning to FIG. 8, there is shown a perspective view of an embodiment of a sealing device for pipes, drains and traps. The sealing device 800 has an upper and lower end. The grate 801 forms the upper end, and when in use would at or near the surface of a floor or the surface of the ground, road, etc. The device has an annular member 802 that connects the grate 801 to the housing 803. In this manner, the annular member 802 places the grate 801 in fluid communication with the housing 803. The housing 803 has two post members 810 and 811, and two windows 812, 813. The housing 803 has an outer surface 803a. The housing has an upper member 805 and a lower member 806. The upper and lower members 805, 806 can be lips, shoulders, ledges, ridges and are used to position and hold the external pipe engagement rings 807, 808. In embodiments one or both of the shoulder can be absent. External rings 807, 808 are made from flexible, rubber, elastic type materials. Upper external ring 807 and lower external ring 808 contact, and contract against the outer surface 803, of the housing 802 and in this manner are held against the housing and held in place. In this embodiment, the lower external ring 806 presses in the outer surface 803a of the lower section of the housing 803, closing the gap 804, (e.g., spit ring configuration of lower section of housing), and in so doing presses the housing inner surface against the sealing member 815. Thus, the external ring 808 holds the components of the lower section of the device 800 in place.

The external rings 807, 808 extend outward (e.g., radially) away from the housing and have a radially outer ends 807a, 808a, that engage against the inner surface of the pipe.

The device has a float 814 that in the sealed position engages against the sealing ring 815, having an inner serrated or grooved sealing end 821. The sealing ring 815 is shown uninstalled in FIG. 8, where the inner serrated end 821 can be seen. The float 814 engages against the inner serrated edge 821 of the sealing member 815

The device 800 also has an upper sealing assembly 830, located inside of the annular member 802. In this embodiment, the upper sealing assembly uses a split ring 831 (shown in the uninserted configuration in FIG. 8B). The split ring 831 is fitted inside of annular member 802 and forms an inner ledge that stops the upward movement of the float, and seals the device. When installed the ring 831 will form a continuous ledge or shoulder on the inside of annular member 802. Thus, for example, if water was backing up in the pipe, the float would rise in the housing, engage the upper sealing member, seal the device, and prevent the water from flowing out of the grate. This could thus prevent, for example, the backup of sewage in basements.

The use of press fit, elastics, glue, ultrasonic welding, molding, unitary molding, over molding, as well as other joining, manufacturing and assembling techniques and technologies can be used to make and assemble the present devices.

The various embodiments of devices, articles, components, parts, uses, applications, methods, activities and operations set forth in this specification may be used for various other fields and for various other activities, uses and embodiments. Additionally, these embodiments, for example, may be used with: existing systems, articles, components, operations or activities; may be used with systems, articles, components, operations or activities that may be developed in the future; and with such systems, articles, components, operations or activities that may be modified, in-part, based on the teachings of this specification. Further, the various embodiments and examples set forth in this specification may be used with each other, in whole or in part, and in different and various combinations. Thus, for example, the configurations provided in the various embodiments and examples of this specification may be used with each other; and the scope of protection afforded the present inventions should not be limited to a particular embodiment, example, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

What is claimed:

1. A device for retrofitting a pipe to block insect access to standing water in the pipe, the device comprising:
a. a stopper capable of moving from a first position to a second position;
b. a sealing member, wherein the stopper engages the sealing member in the first position and thereby forms an insect blocking seal;
c. the stopper capable of moving to the second position by the action of in-flow water, wherein the movement of the stopper opens a channel for the flow of the in-flow water past the stopper and the sealing member; and
d. wherein the stopper is capable of returning to the first position up the sensation of the in-flow water.

2. The device of claim 1, wherein the stopper is a hinged flap.

3. The device of claim 1, wherein the stopper is a float.

4. The device of claim 3, wherein the stopper is spherical.

5. The device of claim 4, wherein the device comprises a float guide.

6. The device of claim 4, wherein the device comprises a plurality of float guides.

7. The device of claim 5, wherein the float guide is a treaded rod.

8. The device of claim 3, wherein the sealing member is a ring.

9. The device of claim 1, wherein the sealing member has an inner serrated edge for engagement with the stopper.

10. The method of retrofitting a drain, having a trap capable of holding standing water, the method comprising:
a. installing the device of claim 1, into the drain opening.

11. A method of blocking insect access to standing water in a trap, the method comprising: providing a float device in engagement with a sealing member in a pipe above standing water in a trap in the pipe, and between the trap and an opening of a pipe in fluid communication with the trap, the float device engaging with the sealing member and thereby preventing insects from traveling past the sealing member, wherein the insects cannot reach standing water in the trap; upon the in-flow of water into the opening the float floats way from the sealing member, whereby a flow passage is opened; flowing the in-flow water through the pipe into the trap and out of the trap; wherein when the in-flow water subsides the trap remains filled with standing water, sealing the trap, and wherein the float re-engages with the sealing member, thereby blocking insect access to the standing water in the trap.

12. A device for blocking insect access to standing water in a trap, the device comprising:
a. a grating;
b. a first annular member;
c. a housing; the housing having an upper end and a lower end and comprising a first post, a second post, a first window, and a second window;
d. the first annular member connecting the grating to the upper end of the housing, whereby the grating is in fluid communication with the housing;
e. the housing having an upper and a lower external selling ring, the sealing rings positioned adjacent an outer surface of the housing, and capable of engaging the inner surface of a pipe;
f. a stopper located in the housing, and movable from a first position within the housing to a second position within the housing; and,
g. a sealing member located within the housing and positioned near the lower end of the housing, wherein the stopper engages the sealing member in the first position and thereby forms an insect blocking seal.

13. The device of claim 12, wherein the sealing member has an inner serrated edge for engagement with the stopper.

14. The device of claim 12, wherein the first annular member has an upper sealing means comprising an inner split ring.

15. The device of claim 12, wherein the lower end of the housing comprises a gap.
